(19) United States
(12) Patent Application Publication
(10) Pub. No.: US 2012/0183825 A1
(43) Pub. Date: Jul. 19, 2012

(54) SECONDARY BATTERY AND METHOD OF MANUFACTURING THE SAME

(76) Inventors: Seung-Hun Lee, Yongin-si (KR); Sang-Ho Lee, Yongin-si (KR)

(21) Appl. No.: 13/323,109

(22) Filed: Dec. 12, 2011

Related U.S. Application Data
(60) Provisional application No. 61/432,898, filed on Jan. 14, 2011.

(51) Int. Cl. H01M 10/36; H01M 10/0587; H01M 10/04

(52) U.S. Cl. 429/94; 29/623.2; 29/623.1

(57) ABSTRACT

An embodiment is directed to a battery, including a housing, an electrode assembly in the housing, the electrode assembly including a first electrode member, a separator, and a second electrode member wound about a first axis, the first axis extending in a first direction, the electrode assembly having a thickness in a second direction orthogonal to the first direction and having a length in a third direction orthogonal to the first and second directions, the length being greater than the thickness, the electrode assembly having a curvature about a second axis that is parallel to the first axis, and first and second electrode tabs, the first electrode tab and the second electrode tab being connected to the first electrode member and the second electrode member, respectively, the first and second electrode tabs protruding from the electrode assembly in a direction orthogonal to the first direction.

### CROSS-REFERENCE TO RELATED APPLICATION

This application claims priority to pending U.S. Provisional Application No. 61/432,898, filed in the U.S. Patent and Trademark Office on Jan. 14, 2011, and entitled “SECONDARY BATTERY AND METHOD OF MANUFACTURING THE SAME,” which is incorporated by reference herein in its entirety and for all purposes.

### BACKGROUND

1. Field

Embodiments relate to a secondary battery and a method of manufacturing the same.

2. Description of the Related Art

A lithium secondary battery having high output and high energy density is being developed as a power supply of portable electronic devices. Recently, there is a demand for smaller and lighter portable electronic devices. Thus, a smaller and lighter secondary battery is also needed for electronic devices using the secondary battery.

### SUMMARY

An embodiment is directed to a battery, including a housing, an electrode assembly in the housing, the electrode assembly including a first electrode member, a separator, and a second electrode member wound about a first axis, the first axis extending in a first direction, the electrode assembly having a thickness in a second direction orthogonal to the first direction and having a length in a third direction orthogonal to the first and second directions, the length being greater than the thickness, the electrode assembly having a curvature about a second axis that is parallel to the first axis, and first and second electrode tabs, the first electrode tab and the second electrode tab being connected to the first electrode member and the second electrode member, respectively, the first and second electrode tabs protruding from the electrode assembly in a direction orthogonal to the first direction.

The housing may have a curvature, and the curvature of the housing may be substantially the same as the curvature of the electrode assembly.

The housing may have a curvature, and the curvature of the housing may follow the curvature of the electrode assembly.

The housing may be a pouch, the pouch having a seal, and the first and second electrode tabs may extend through the seal.

The pouch may include a first portion and a second portion, the second portion having a recess therein that accommodates the electrode assembly, the first portion covering the recess, and the pouch may be curved toward the first portion.

The pouch may be curved such that the first portion is between the second axis and the second portion.

The pouch may include a first portion and a second portion, the second portion having a recess therein that accommodates the electrode assembly, the first portion covering the recess, and the pouch may be curved toward the second portion.

The pouch may be curved such that the second portion is between the second axis and the first portion.

The pouch may be a single piece of material having a fold therein, the material being sealed to itself on first, second, and third sides, the third side connecting the first and second sides, the fold forming a fourth side that is opposite the third side and between the first and second sides, and the first and second electrode tabs may protrude through the seal at the third side.

The housing may be a case having an opening, the opening being closed by a cap assembly, and the electrode assembly may be disposed in the case such that the first axis is parallel to a major plane of the cap assembly, and the first and second electrode tabs extend toward the cap assembly.

The case may be curved such that an outside surface of a side of the battery forms a concave region.

The case may have a curvature about the second axis, the concave region facing the second axis.

Another embodiment is directed to a method of fabricating a battery having an electrode assembly and first and second electrode tabs protruding from the electrode assembly, the method including providing a housing, disposing the electrode assembly in the housing, the electrode assembly including a first electrode member, a separator, and a second electrode member wound about a first axis, the first axis extending in a first direction, the electrode assembly having a thickness in a second direction orthogonal to the first direction and having a length in a third direction orthogonal to the first and second directions, the length being greater than the thickness, the first electrode tab and the second electrode tab being connected to the first electrode member and the second electrode member, respectively, the first and second electrode tabs protruding from the electrode assembly in a direction orthogonal to the first direction, and forming the electrode assembly to have a curvature about a second axis that is parallel to the first axis.

The method may further include disposing an electrolyte prepolymer in the housing, and thermally hardening the prepolymer in the housing so as to form a solid electrolyte.

Forming the electrode assembly to have a curvature may be performed before disposing the electrode assembly in the housing.

The method may further include forming the housing to have a curvature, the curvature of the housing being substantially the same as the curvature of the electrode assembly.

Forming the electrode assembly to have a curvature may be performed after disposing the electrode assembly in the housing.

The method may further include disposing an electrolyte prepolymer in the housing, and thermally hardening the prepolymer in the housing so as to form a solid electrolyte.

Disposing the electrolyte prepolymer in the housing may be performed after disposing the electrode assembly in the housing.

### BRIEF DESCRIPTION OF THE DRAWINGS

The above and other features and advantages will become more apparent to those of skill in the art by describing in detail example embodiments with reference to the attached drawings, in which:

FIG. 1 illustrates an exploded perspective view of an electrode assembly according to an example embodiment;

FIG. 2 schematically illustrates a process of forming an electrode assembly according to an example embodiment;

FIG. 3A illustrates a perspective view of the electrode assembly wound in FIG. 2;

FIG. 3B illustrates a lateral view of the electrode assembly of FIG. 3A;

FIG. 4 illustrates a perspective of the electrode assembly and a battery case to accommodate the electrode assembly according to an example embodiment;

FIG. 5 illustrates a perspective view of a secondary battery before having a curved shape according to an example embodiment;

FIGS. 6A and B illustrate projection views of a lateral side of the pouch-type secondary battery having a curved cross section vertical to a winding axis according to example embodiments;

FIG. 7 illustrates an exploded perspective view of an electrode assembly and a battery case accommodating the electrode assembly according to another example embodiment;

FIG. 8 illustrates a perspective view of a secondary battery before having a curved shape according to the other example embodiment; and

FIG. 9 illustrates a perspective view of the angular secondary battery having a curved cross section vertical to a winding axis according to the other example embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

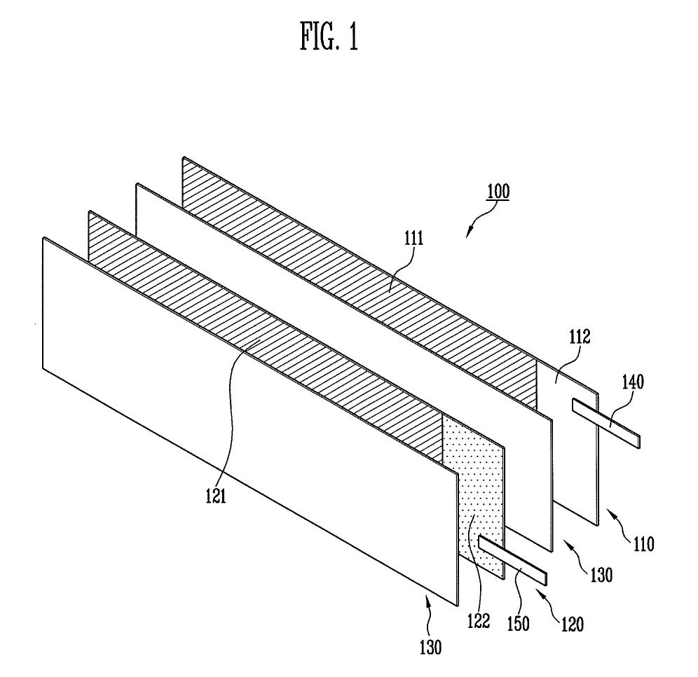

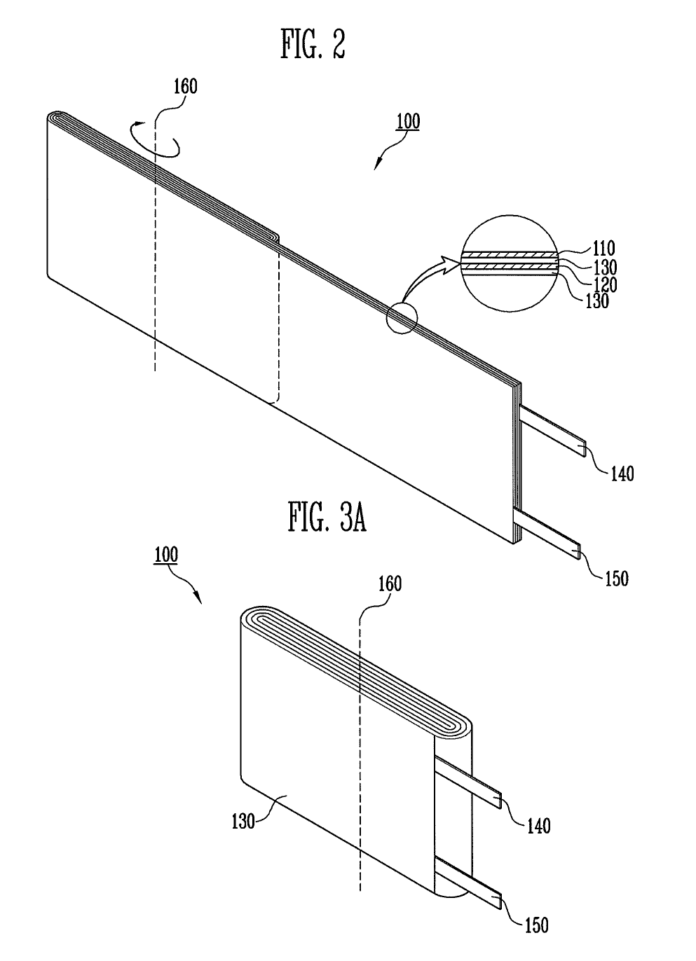

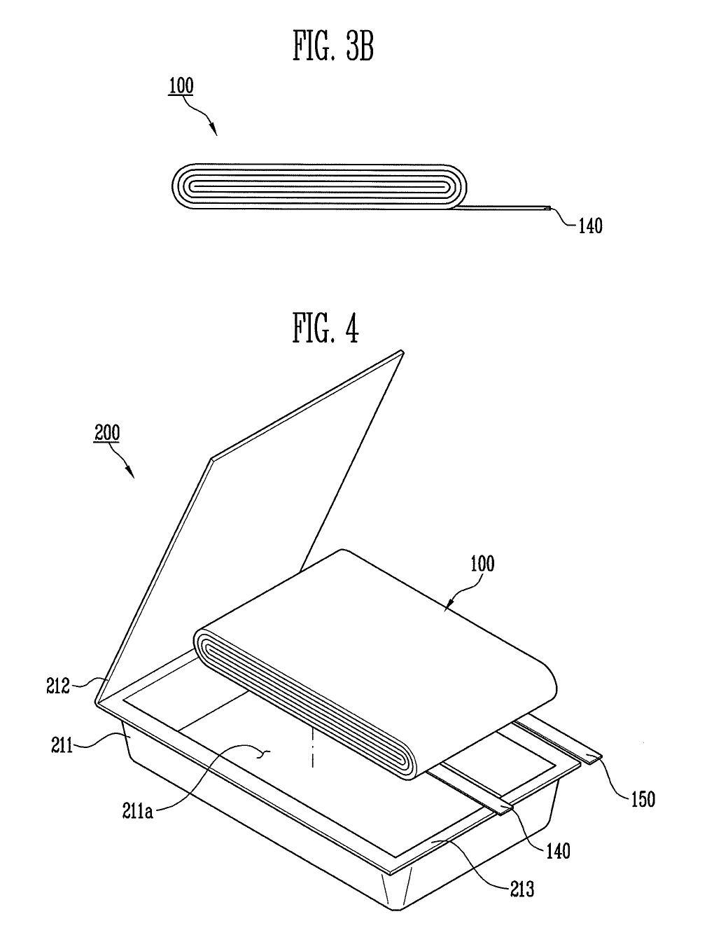

FIG. 1 illustrates an exploded perspective view of an electrode assembly according to an example embodiment. FIGS. 2, 3A, and 3B schematically illustrate a process of forming an electrode assembly according to an example embodiment. FIG. 2 schematically illustrates a process of forming an electrode assembly by winding a first electrode member, a second electrode member, and a separator.

In the example shown in FIG. 1, the electrode assembly 100 includes a positive electrode member 110, a negative electrode member 120, and a separator 130.

The positive electrode member 110 and the negative electrode member 120 may be electrically connected directly to an outside via a first electrode tab 140 and a second electrode tab 150 being respectively attached to the positive electrode member 110 and the negative electrode member 120, or may be electrically connected to the outside through a separate electrode lead (not shown).

The positive electrode member 110 may include a positive active material layer 111 (where a positive active material is applied to one or both sides of a positive current collector) and a first non-applied part 112 where the positive active material is not applied.

Generally, the positive current collector may include any suitable material that has a high conductivity and does not cause chemical changes. For example, the positive current collector may use aluminum, nickel, titanium, baked carbon, or the like. The positive active material layer 111 may be formed by applying slurry to the positive current collector, the slurry being prepared by mixing the positive active material (which is a layered compound including lithium, a conductive material to improve conductivity, and a binder to improve coherence of materials) with a solvent.

The negative electrode member 120 may include a negative active material layer 121 (where a negative active material is applied to one or both sides of a negative current collector) and a second non-applied part 122 where the negative active material is not applied.

Generally, the negative current collector may include a conductive metal plate, for example, copper, stainless steel, aluminum, nickel, or the like. The negative active material layer 121 may be formed by applying slurry to the negative current collector, the slurry being prepared by mixing the negative active material and a binder (to improve coherence of the negative active material) with a solvent.

In the example shown in FIG. 1, the separator 130 is disposed between the positive electrode member 110 and the negative electrode member 120. The separator 130 may be formed of an insulating thin film having a high ion permeability and a high mechanical strength, and may function to pass ions while preventing direct contact of the positive electrode member 110 with the negative electrode member 120. For example, the separator 130 may include polyethylene, polypropylene, polyvinylidene fluoride, or the like.

As shown in FIG. 1, the first electrode tab 140 and the second electrode tab 150 may be respectively attached to the first non-applied part 112 of the positive electrode member 110 and the second non-applied part 122 of the negative electrode member 120, e.g., via at least one process of ultrasonic welding, resistance welding, and laser welding, or may be integrated with the positive electrode member 110 and the negative electrode member 120. For example, the first electrode tab 140 and the second electrode tab 150 may be formed of nickel, aluminum, or the like.

FIG. 3A illustrates a perspective view of the electrode assembly wound in FIG. 2, and FIG. 3B illustrates a lateral view of the electrode assembly of FIG. 3A.

In the example shown in FIGS. 2, 3A, and 3B, the electrode assembly 100 is formed by winding the positive electrode member 110, the separator 130, and the negative electrode member 120 in a predetermined width based on a winding axis 160. In FIG. 3A, the winding axis extends in a first direction, in a width direction of the electrode assembly 100. The electrode assembly 100 may have a thickness in a second direction orthogonal to the first direction, i.e., in a vertical direction in FIG. 3B, and may have a length in a third direction orthogonal to the first and second directions, i.e., in a horizontal direction in FIG. 3B.

In FIG. 3A, the first electrode tab 140 and the second electrode tab 150 attached to the positive electrode member 110 and the negative electrode member 120 are exposed to the outside through an outmost side of the wound electrode assembly 100 and extend parallel with the winding direction. Further, as shown in FIG. 3B, the electrode assembly 100 may have an oval cross section.

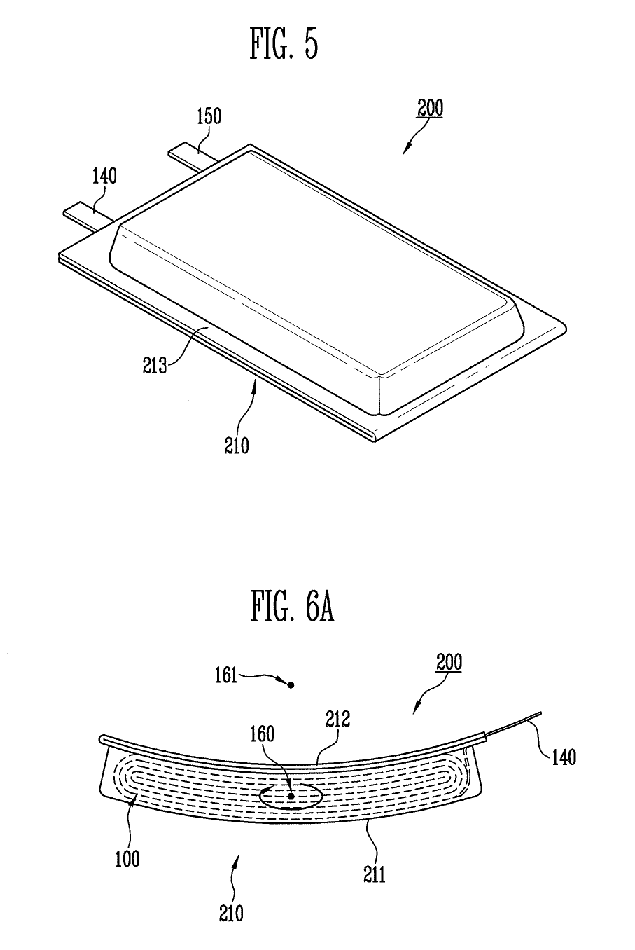

FIG. 4 illustrates a perspective of the electrode assembly of FIG. 3 and a battery case to accommodate the electrode assembly.

Referring to FIG. 4, a secondary battery 200 according to an example embodiment may be formed by accommodating the above electrode assembly 100 and an electrolyte in a battery case, e.g., a pouch-type battery case, and sealing the battery case.

In the pouch-type secondary battery 200 of the present embodiment, the first electrode tab 140 and the second electrode tab 150 may be exposed to the outside of the pouch-type case through a sealing portion of the pouch-type case. The first electrode tab 140 and the second electrode tab 150 may function to conduct electrons (generated through a chemical reaction between the electrode members and the electrolyte) and are electrically connected to the outside.

In the example shown in FIG. 4, the first electrode tab 140 and the second electrode tab 150 extend parallel with a winding direction of the electrode members. This configuration may help avoid a situation, when the electrode tabs 140 and 150 are formed vertically to the electrode assembly while the secondary battery case accommodating the electrode tabs 140 and 150 and the electrolyte is curved in the winding direction of the electrode assembly, in which the electrode tabs 140 and 150, the positive electrode member 110, and the negative electrode member 120 are deformatively curved to cause damage to the positive electrode member 110 and the negative electrode member 120, or the electrode tabs 140 and 150. Thus, in the present embodiment, the electrode tabs 140 and 150 may extend parallel with the winding direction of the electrode assembly and be integrated or separately attached.

Referring to FIG. 4, the electrode assembly 100 is accommodated along with an electrolyte in a battery case 210. The electrolyte may use a solution prepared by dissolving lithium salts, such as LiPF₆ and LiBF₄, and various additives in an organic solvent. A useful electrolyte dissolves a suitable amount of lithium salts and has a low viscosity. The electrolyte may be inactive on a surface of the positive electrode member 110 and the negative electrode member 120 during charging and discharging of the secondary battery. For example, materials of the electrolyte may include at least one of ethylene carbonate (EC), propylene carbonate (PC), dimethyl carbonate (DMC), diethyl carbonate (DEC), and ethyl methyl carbonate (EMC).

In another implementation, the electrolyte may use polymer gel as a solid electrolyte. The electrolyte using the polymer gel may provide a high boiling point to be stable against combustion and to prevent the electrolyte from leaking. Example materials of the polymer gel may include at least one of polyethylene glycol (PEG), polyacrylonitrile (PAN), polymethylmethacrylate (PMMA), and polyvinyldifluoride (PVDF).

The polymer gel may be formed by a gelation of a prepolymer. The prepolymer refers to a precursor of a polymer, and the polymer gel may be formed by accommodating the prepolymer in the battery case and heating the battery case accommodating the prepolymer.

When the electrolyte uses the above polymer gel, the secondary battery case accommodating the electrode assembly and the electrolyte may first be curved in a direction parallel with the winding direction of the electrode assembly, and then be thermally hardened.

In the present example embodiment, the battery case 210 is shown as a pouch-type case that includes a body 211 and a cover 212. The secondary battery 200 may be manufactured by disposing the electrode assembly 100 in an accommodating part 211a of the body 211, and thermally sealing a sealing portion 213 with the body 211 and the cover 212 being closely attached to each other.

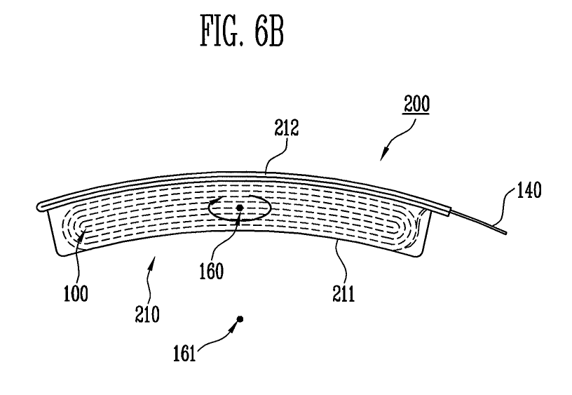

FIG. 5 illustrates a perspective view of a secondary battery where the electrode assembly and the electrolyte are accommodated and sealed before having a curved shape, and FIGS. 6A and 6B illustrate respective projection views of a lateral side of the pouch-type secondary battery having a curved cross section vertical to the winding axis according to the present embodiment.

In the example shown in FIG. 5, the pouch-type battery case 210 accommodates the electrode assembly 100 and the electrolyte inside and is sealed through a thermal sealing process or the like. For example, the sealing portion 213 of the battery case 210 and the cover 212 in contact with the sealing portion 213 may be heated at a predetermined temperature or more, and pressed using a pressing jig. In the example shown in FIG. 5, the first electrode tab 140 and the second electrode tab 150 are exposed through the sealing portion 213. Further, as shown in FIG. 5, the first electrode tab 140 and the second electrode tab 150 are spaced apart from each other.

In the examples shown in FIGS. 6A and 6B, in order to have the curved cross section vertical to the winding axis, curving is performed in the direction parallel with the winding axis of the electrode assembly. In detail, the secondary battery 200 shown in FIG. 5 is a flat shape. When the secondary battery 200 is mounted in a curved part of an electronic device, spatial use may be inefficient and prevent the electronic device from being smaller and slimmer. Thus, as shown in FIGS. 6A and 6B, to curve the secondary battery 200, opposite end portions may be smoothly curved in the same direction based on the winding axis (refer to FIG. 3A) of the electrode assembly 100 with respect to a central part of a cross section vertical to the winding axis. Thus, as illustrated both of the opposite end portions may be curved upwards (FIG. 6A) or downwards (FIG. 6B) based on a horizontal surface with respect to the central part.

In the examples shown in FIGS. 6A and 6B, the secondary battery 200 accommodating the electrode assembly 100 is curved, so that the battery case 210 and the electrode assembly 100 in the battery case 210 are curved the same. A curving direction of the electrode assembly 100 is parallel with the winding direction. As shown in FIGS. 6A and 6B, in the electrode assembly 100, a surface vertical to the first electrode tab 140 and the second electrode tab 150 has a narrow width, whereas a surface horizontal with the electrode tabs 140 and 150 has a relatively broad width. Thus, the electrode assembly 100 is curved based on the surface having a relatively broader width. Accordingly, a force exerted on the electrode assembly 100 is dispersed to prevent the electrode assembly 100 from being damaged. Thus, a capacity and a lifespan of the secondary battery 200 may be improved.

As discussed above, the electrolyte may use a general liquid electrolyte or a solid electrolyte. When the solid electrolyte is used, the secondary battery 200 may be curved and then be thermally hardened. Thus, when the secondary battery 200 uses a polymer gel as the solid electrolyte, as described above, a prepolymer may be accommodated with the electrode assembly 100 in the battery case 210 and be thermally hardened. According to the thermal hardening process, the prepolymer becomes a polymer gel. Here, the thermal hardening process may be performed after curving the electrode assembly 100. The polymer gel may be a cross-linked polymer, and thus the secondary battery 200 may increase in strength due to the polymer gel. Accordingly, the secondary battery 200 may not be easily deformed by external impact, and may thus be stably used.

On the other hand, it may be difficult when the prepolymer is thermally hardened before the secondary battery 200 is curved because of decreases in fluidity of the thermally hardened polymer gel. Thus, the polymer gel may harden a surface of the electrode assembly 100 and surroundings thereof. For example, if the electrode assembly 100 is curved after the polymer gel is thermally hardened, the active material layers of the first electrode member and the second electrode member forming the electrode assembly 100 may peel off. In contrast, according to the present embodiment, the prepolymer is a solution when the electrode assembly 100 is formed into a curved shape, i.e., before being thermally hardened. Thus, when the electrode assembly 100 is curved and the electrolyte is in the state of the prepolymer, the above peeling off problem or the like may be prevented.

A method of curing the secondary battery 200 may include pressing and thermally processing the secondary battery 200. The pressing and the thermally processing may be performed at a temperature where the electrode assembly 100 accommodated in the secondary battery 200 and the electrolyte are minimally deteriorated. In an implementation, the pressing and the thermally processing may be performed at normal temperature without a heating process.

In the embodiment described above, the secondary battery 200 is curved, and thus the electrode assembly 100 accommodated therein is also curved in the same shape as the secondary battery 200.

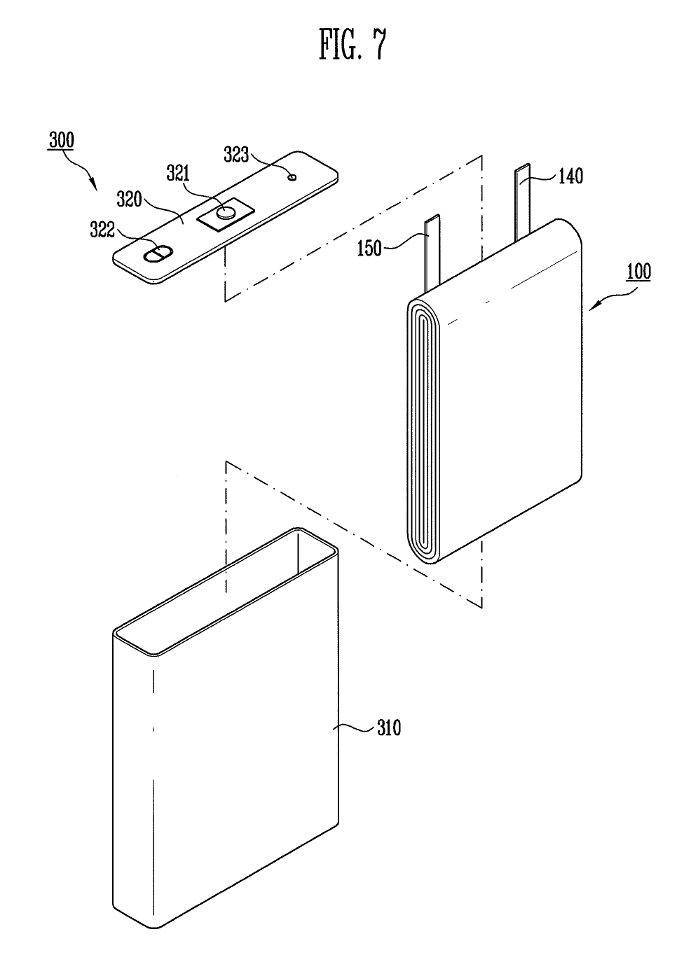

FIGS. 7 to 9 illustrate another example embodiment. FIG. 7 illustrates an exploded view of an electrode assembly and a battery case accommodating the electrode assembly.

In the example shown in FIG. 7, a secondary battery 300 according to the present embodiment includes the battery case 310 having one open side, a cap assembly 320 to cover the open side, and the electrode assembly 100 accommodated in the battery case 310. The battery case 310 accommodates an electrolyte along with the electrode assembly 100 inside, where the electrode assembly 100 may be the same as that described above in connection with FIG. 2. Through electrode tabs 140 and 150, the secondary battery 300 may be electrically connected to a device.

The secondary battery 300 of the present embodiment may include an angular battery case 310. The angular battery case 310 may accommodate the electrode assembly 100 and a liquid or solid electrolyte, described above. The cap assembly 320 may be assembled to an upper part of the angular battery case 310 and seal the open side of the angular battery case 310 so that the electrode assembly 100 is not detached from the angular battery case 310.

In the example shown in FIG. 7, the cap assembly 320 seals the open side of the angular battery case 310. The cap assembly 320 includes a negative pin 321, a safety vent 322, and an electrolyte inlet 323 on a cap plate as a board.

The second electrode tab 150 may be bent in a zigzag and is welded to a lower end of the negative pin 321. Further, the first electrode tab 140 may be welded with the cap plate. A method of coupling the first electrode tab 140 and the second electrode tab 150 may include, e.g., resistance welding, laser welding, or the like. Resistance welding may be generally used.

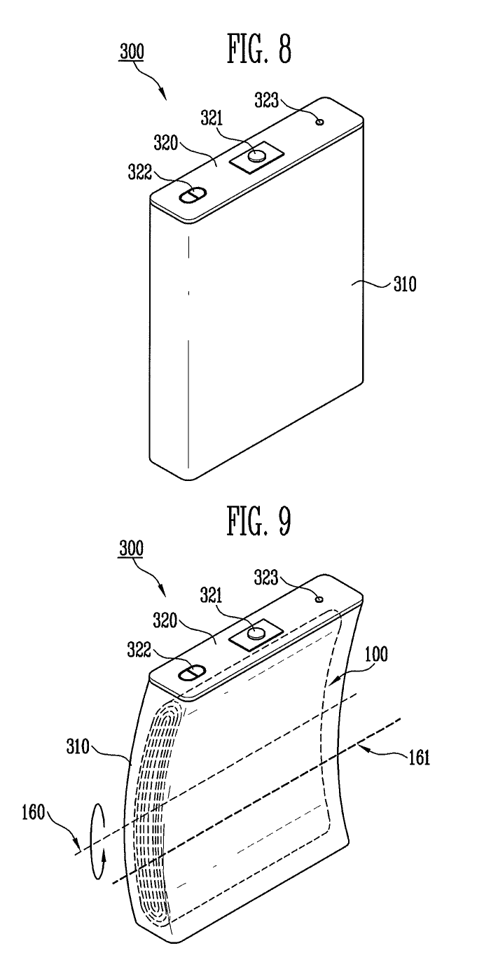

FIG. 8 illustrates a perspective view of the secondary battery before being formed to have a curved shape, and FIG. 9 illustrates a perspective view of the angular secondary battery after being formed to have a curved cross section vertical to a winding axis.

In the example shown in FIG. 8, the angular battery case 310 accommodates the electrode assembly 100 and the electrolyte inside, and is sealed by the cap assembly 320. For example, an edge of the cap assembly 320 may be welded with a corner of the open side of the angular battery case 310.

The angular secondary battery 300 shown in FIG. 8 is a hexahedron having flat external surfaces. As described above, when the secondary battery 300 of FIG. 8 is mounted in a curved part of an electronic device, spatial use may be inefficient. Thus, the secondary battery according to the present embodiment may be formed to have a curved cross section vertical to the winding axis (refer to FIG. 3A). In detail, in the secondary battery 300, the cap assembly 320 and a bottom side positioned corresponding to the cap assembly 320 extend in the same direction. For example, both the cap assembly 320 and the bottom side may be curved upwards (like in FIG. 6A) or downward (like in FIG. 6B) to look in the same direction based on a horizontal surface with respect to a central part.

As the angular secondary battery 300 is curved, the electrode assembly 100 accommodated in the secondary battery 300 may also be curved in the same direction. The curving direction of the electrode assembly 100 may be the same as the winding direction of the electrode assembly 100. The electrode assembly 100 may be curved based on a relatively broader width of the electrode assembly 100. As a width of a curved part becomes broader, a radius of curvature increases, and thus a force exerted on the electrode members may be dispersed. Accordingly, the first and second electrode members (refer to FIG. 2) may be prevented from being broken.

A method of curving the secondary battery 300 may use a jig having a shape that corresponds to a curved shape of the secondary battery 300. Heat processing may be used along with the jig to ease curving. The curving may be performed under conditions where the electrolyte is minimally deteriorated. In other aspects, the electrolyte and the method of curving the secondary battery may be the same as described above with reference to FIG. 6, and thus descriptions thereof are omitted.

By way of summation and review, embodiments may provide a secondary battery that efficiently uses a space where the secondary battery is accommodated based on an external appearance of an electronic device using the secondary battery as a power supply, and a method of manufacturing the same. Embodiments may also provide a secondary battery having a curved shape to be stably installed in an electronic device even though the electronic device has a curved external appearance. Thus, the secondary battery may not move, but instead may be stabled fixed in the electronic device. Embodiments may also provide a secondary battery which is smoothly curved so that an electrode assembly of the secondary battery is not broken, and a method of manufacturing the same.

As described above, according to example embodiments, when a secondary battery is mounted in an electronic device having a curved shape, an inside space of the electronic device is efficiently used to enable the electronic device to be smaller and lighter. Further, when a secondary battery is suitably mounted corresponding to an electronic device having a curved external shape, the secondary battery may not be easily moved by external impact to be stably used. Also, even though the electrode assembly is curved the same as the secondary battery, electrode plates of the electrode assembly may be securely formed without being broken or damaged.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery, comprising:
a housing;
an electrode assembly in the housing, the electrode assembly including a first electrode member, a separator, and a second electrode member wound about a first axis, the first axis extending in a first direction, the electrode assembly having a thickness in a second direction orthogonal to the first direction and having a length in a third direction orthogonal to the first and second directions, the length being greater than the thickness, the electrode assembly having a curvature about a second axis that is parallel to the first axis; and
first and second electrode tabs, the first electrode tab and the second electrode tab being connected to the first electrode member and the second electrode member, respectively, the first and second electrode tabs protruding from the electrode assembly in a direction orthogonal to the first direction.

2. The battery as claimed in claim 1, wherein the housing has a curvature, and the curvature of the housing is substantially the same as the curvature of the electrode assembly.

3. The battery as claimed in claim 1, wherein the housing has a curvature, and the curvature of the housing follows the curvature of the electrode assembly.

4. The battery as claimed in claim 1, wherein:
the housing is a pouch, the pouch having a seal, and
the first and second electrode tabs extend through the seal.

5. The battery as claimed in claim 4, wherein:
the pouch includes a first portion and a second portion, the second portion having a recess therein that accommodates the electrode assembly, the first portion covering the recess, and
the pouch is curved toward the first portion.

6. The battery as claimed in claim 5, wherein the pouch is curved such that the first portion is between the second axis and the second portion.

7. The battery as claimed in claim 6, wherein:
the pouch includes a first portion and a second portion, the second portion having a recess therein that accommodates the electrode assembly, the first portion covering the recess, and
the pouch is curved toward the second portion.

8. The battery as claimed in claim 7, wherein the pouch is curved such that the second portion is between the second axis and the first portion.

9. The battery as claimed in claim 6, wherein:
the pouch is a single piece of material having a fold therein, the material being sealed to itself on first, second, and third sides, the third side connecting the first and second sides, the fold forming a fourth side that is opposite the third side and between the first and second sides, and
the first and second electrode tabs protrude through the seal at the third side.

10. The battery as claimed in claim 1, wherein:
the housing is a case having an opening, the opening being closed by a cap assembly, and
the electrode assembly is disposed in the case such that the first axis is parallel to a major plane of the cap assembly, and the first and second electrode tabs extend toward the cap assembly.

11. The battery as claimed in claim 10, wherein the case is curved such that an outside surface of a side of the battery forms a concave region.

12. The battery as claimed in claim 11, wherein the case has a curvature about the second axis, the concave region facing the second axis.

13. A method of fabricating a battery having an electrode assembly and first and second electrode tabs protruding from the electrode assembly, the method comprising:
providing a housing;
disposing the electrode assembly in the housing, the electrode assembly including a first electrode member, a separator, and a second electrode member wound about a first axis, the first axis extending in a first direction, the electrode assembly having a thickness in a second direction orthogonal to the first direction and having a length in a third direction orthogonal to the first and second directions, the length being greater than the thickness, the first electrode tab and the second electrode tab being connected to the first electrode member and the second electrode member, respectively, the first and second electrode tabs protruding from the electrode assembly in a direction orthogonal to the first direction; and
forming the electrode assembly to have a curvature about a second axis that is parallel to the first axis.

14. The method as claimed in claim 13, further comprising:
disposing an electrolyte prepolymer in the housing; and
thermally hardening the prepolymer in the housing so as to form a solid electrolyte.

15. The method as claimed in claim 13, wherein forming the electrode assembly to have a curvature is performed before disposing the electrode assembly in the housing.

16. The method as claimed in claim 13, further comprising forming the housing to have a curvature, the curvature of the housing being substantially the same as the curvature of the electrode assembly.

17. The method as claimed in claim 16, wherein forming the electrode assembly to have a curvature is performed after disposing the electrode assembly in the housing.

18. The method as claimed in claim 17, further comprising:
disposing an electrolyte prepolymer in the housing; and
thermally hardening the prepolymer in the housing so as to form a solid electrolyte.

19. The method as claimed in claim 18, wherein disposing the electrolyte prepolymer in the housing is performed after disposing the electrode assembly in the housing.
